(19) United States
(12) Patent Application Publication
(10) Pub. No.: US 2007/0007877 A1
(43) Pub. Date: Jan. 11, 2007

(54) Arc tube array type display device and driving method for the same

(75) Inventors: Manabu Ishimoto, Kawasaki (JP); Kenji Awamoto, Kawasaki (JP); Yosuke Yamazaki, Kawasaki (JP); Hitoshi Hirakawa, Kawasaki (JP); Akira Tokai, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/521,314

(22) Filed: Sep. 15, 2006

Related U.S. Application Data
(63) Continuation of application No. PCT/JP04/04737, filed on Mar. 31, 2004.

(51) Int. Cl. H01J 1/62

(52) U.S. Cl. 313/488; 345/60; 313/582; 313/484

(57) ABSTRACT

A plurality of arc tubes are arranged in parallel with the long side of a rectangular screen, a plurality of first electrodes and second electrodes are arranged on the display surface side of the arc tube array in the direction intersecting the longitudinal direction of the arc tubes, and a plurality of third electrodes are arranged on the back side of the arc tube array along the longitudinal direction of the arc tubes. At the time of screen display, the third electrodes are used as scan electrodes and a scan voltage is applied sequentially to the plurality of third electrodes. In the meantime, a voltage is applied to a desired first electrode or second electrode so that discharge takes place in a desired light-emitting cell and a light-emitting cell is selected. Thereafter, display discharge takes place between the adjacent first electrode and second electrode thus performing display.

### TECHNICAL FIELD

The present invention relates to an arc tube array type display device and a driving method of the same. In particular, the present invention relates to an arc tube array type display device in which a phosphor layer is provided inside a narrow tube having a diameter of about 0.5 to 5 mm and a plurality of arc tubes (also called as “display tubes” or “gas discharge tubes”) filled with discharge gas are arranged in parallel to thereby display any image, and to a driving method of the same.

### BACKGROUND ART

As this kind of arc tube array type display device, those described in Japanese Patent Laid-Open Publication No. 2003-86141 and Japanese Patent Laid-Open Publication No. 2003-86142 are known. FIGS. 9 and 10 show an example thereoL FIG. 10 is a partial sectional view of FIG. 9, showing a state in which the display device is cut along a direction orthogonal to the longitudinal direction of the arc tubes.

In the arc tube array type display device, the display device is configured such that a plurality of arc tubes 1 (arc tube array) arranged in parallel are held between a pair of plate-shaped supports 41 and 42 made of glass, resin or the like. Further, one using a transparent film sheet as a support is also known. In the arc tubes 1, phosphor layers R for red, phosphor layers G for green and phosphor layers B for blue are provided, and discharge gas is filled therein. The arc tubes 1 for three colors constitute one pixel as a set to thereby realize full-color display.

The display device is adapted to cause discharge inside the arc tubes. Therefore, electrodes are formed on surfaces facing the arc tube array of the supports so as to make the electrodes contact the surfaces of the arc tubes.

These electrodes are generally arranged such that third electrodes A for address (selection) are arranged on the surface facing the arc tube array of the support 42 of the back side along the respective arc tubes, and a number of first electrodes X and second electrodes Y for display are arranged adjacently so as to form electrode pairs on the surface facing the arc tube array of the support 41 on the front side (display surface side) in a direction orthogonal to the third electrodes A.

The first and second electrodes X and Y, for general purpose, are formed of a transparent electrode 43 formed of an ITO film or a SnO₂ film and a bus electrode 44 made of a metallic film. The third electrode A is formed of a metallic film.

FIG. 11 is an illustration showing an exemplary method of driving the arc tube array type display device shown in FIG. 9.

In the arc tube array type display device, driving at the time of display is performed by the address-display separation type subfield method same as a PDP (plasma display panel) of three-electrode surface discharge system. Therefore, examples are shown, in the drawings, of a field configuration and driving voltage waveforms when driving is performed by the address-display separation type subfield method.

In this method, one frame comprises eight subfields sf₁ to sf₈ having different brightness, for example. Even in the display of interlace system in which one frame comprises two fields (odd field, even field) for example, each field fi comprises eight subfields sf₁ to sf₈, similarly. The relating weighting ratio of the brightness of the eight subfields is 1:2:4:8:16:32:64:128.

Each subfield sfj includes a reset period TR to initialize charges of all light-emitting cells (unit light-emitting areas), an address period TA to select a light-emitting cell, and a display period TS to sustain discharge of the light-emitting cell.

In the reset period TR, reset pulse Pr is applied to, for example, the first electrodes X among the display electrodes so as to cause reset discharge with the second electrodes Y.

In the address period TA, the second electrodes Y, among the display electrodes, are used as scan electrodes, and scan pulse Pc is applied sequentially to the second electrodes Y. In the meantime, address pulse Pa is applied to a desired third electrode A so as to cause address discharge at the intersection between the address electrode A and the electrode Y to thereby select an light-emitting area.

In the display period TS, by using a wall charge formed on the tube inner face of the light-emitting area by the address discharge, sustain pulse Ps is applied alternately to the electrodes X and the electrodes Y so as to cause display discharge (may also be called as sustain discharge) between the pair of display electrodes X and Y to thereby perform display.

Thereby, as shown in the arrows in FIG. 10, red light 45 is discharged from the arc tube 1 in which the phosphor layer R for red is formed, green light 46 is discharged from the arc tube 1 in which the phosphor layer G for green in formed, and blue light 47 is discharged from the arc tube 1 in which the phosphor layer B for blue is formed.

Address discharge is opposite discharge caused in the arc tube 1 between the address electrode A and the electrode Y opposite to each other over the arc tube 1, and display discharge is surface discharge caused in the arc tube 1 between the two display electrodes X and Y arranged in parallel on a plane. With such an electrode arrangement, a plurality of light-emitting areas (unit light-emitting areas: light-emitting cells) are formed in the longitudinal direction of the arc tubes.

However, in such an arc tube array type display device, if the screen is in a horizontally long shape, enormous numbers of arc tubes are used when the arc tubes are arranged in the vertical direction, so the manufacturing cost increases.

In order to avoid an increase in the cost, the arc tubes may be arranged in the horizontal direction. In this case, however, in the address period TA, when scanning is performed by using the electrodes Y among the display electrodes as scan electrodes, the number of scan lines increases, whereby the address period TA becomes longer. Usually, one frame is 1/60 (second) and since the above-mentioned periods for one subfield has a limitation, the display period TS becomes shorter correspondingly, whereby the display brightness becomes lower.

The present invention has been developed in view of these circumstances. An object of the present invention is to reduce the manufacturing cost and to increase the display brightness by, if it is an arc tube array type display device having a rectangle screen, arranging arc tubes in parallel with the long side of the rectangular screen, and in the address period, performing scanning by using address electrodes provided along the arc tubes as scan electrodes.

### DISCLOSURE OF THE INVENTION

The present invention provides an arc tube array type display device in which a plurality of arc tubes filled with discharge gas are arranged in parallel, comprising: an arc tube array in which a plurality of arc tubes are arranged in parallel with the long side of a rectangular screen; a plurality of first electrodes and second electrodes arranged on the display surface side of the arc tube array across the respective arc tubes in the direction intersecting a longitudinal direction of the arc tubes, so that display discharge takes place in an arc tube between the adjacent first electrode and second electrode; and a plurality of third electrodes arranged on the back side of the arc tube array for the respective arc tubes along the longitudinal direction of the arc tubes, forming a light-emitting cell at an intersection with the first electrode or the second electrode, wherein, at the time of screen display, the third electrodes provided with each of the arc tubes are used as scan electrodes and a scan voltage is applied sequentially to the plurality of third electrodes, and in the meantime, an address voltage is applied to a desired first electrode or second electrode so that an address discharge takes place in a desired light-emitting cell and a light-emitting cell is selected, and thereafter display discharge takes place between the adjacent first electrode and second electrode thus performing display.

According to the present invention, the number of arc tubes used decreases, so the manufacturing cost can be reduced. Further, when display is performed by using the address-display separation type subfield method, an address period to select a light-emitting cell can be shortened. Thereby, it is possible to extend the display period and to increase the display brightness.

### BRIEF DESCRIPTION OF THE DRAWINGS

FIG. 1 is an illustration showing the overall configuration of an arc tube array type display device of the present invention;

FIG. 2 is an illustration showing an exemplary tube arrangement of the arc tube array;

FIG. 3 is an illustration showing a driver arrangement of the arc tube array type display device;

FIG. 4 is an illustration showing examples of driving voltage waveforms of the arc tube array type display device;

FIG. 5 is an illustration showing a comparative example 1 of the arc tube array type display device;

FIG. 6 is an illustration showing examples of driving voltage waveforms of the arc tube array type display device of the comparative example 1;

FIG. 7 is an illustration showing a comparative example 2 of the arc tube array type display device;

FIG. 8 is an illustration showing examples of driving voltage waveforms of the arc tube array type display device of the comparative example 2;

FIG. 9 is an illustration showing the overall configuration of a conventional arc tube array type display device;

FIG. 10 is a partial sectional view of FIG. 9; and

FIG. 11 is an illustration showing a method of driving the arc tube array type display device shown in FIG. 9.

### BEST MODE FOR CARRYING OUT THE INVENTION

In the present invention, an arc tube array type display device may be so configured as to include a rectangular screen and a plurality of arc tubes filled with discharge gas arranged in parallel with the long side of the rectangular screen. As a narrow tube serving as a tube body of the arc tube, one having any diameter may be used, but it is preferable to use one made of glass having a diameter of 0.5 to 5 mm. The shape of the narrow tube may have any cross section such as a circular section, a flat elliptic section or a square section.

A plurality of first and second electrodes are arranged on the display surface side of the arc tube array in stripes in a direction intersecting the longitudinal direction of the arc tubes, which should be those capable of causing display discharge in the arc tubes between adjacent electrodes.

The first and second electrodes can be formed by using various materials well known in the field. Materials used for the electrodes include transparent conductive materials such as ITO and SnO₂ and metallic conductive materials such as Ag, Au, Al, Cu and Cr. As methods of forming electrodes, various methods well known in the field can be used. For example, electrodes may be formed by using thick-film forming technique such as printing, or may be formed by using thin-film forming technique including physical deposition or chemical deposition. The thick-film forming technique includes screen printing. In the thin-film forming technique, physical deposition includes vapor deposition and sputtering, and chemical deposition includes thermal CVD, optical CVD, and plasma CVD.

A plurality of third electrodes are provided on the back surface of the arc tube array for respective arc tubes along the longitudinal direction of the arc tubes, which should be those for selecting light-emitting cells forming light-emitting cells at intersections with display electrodes.

The third electrodes can also be formed by using various materials and methods well-known in the field.

In the present invention, screen display is performed in the following manner. That is, a scan voltage is applied sequentially to the third electrodes, provided for the respective arc tubes, used as scan electrodes. In the meantime, an address voltage is applied to a desired first electrode or second electrode so as to cause address discharge in a desired light-emitting cell to thereby select a light-emitting cell. Then, display discharge is caused between the first electrode and the second electrode.

In the configuration described above, it is desirable that each the arc tube array includes a phosphor layer of a single color, for example, an arc tube for red color, an arc tube for green color, and an arc tube for blue color.

It is desirable that the arc tube array type display device be an arc tube array type display device in which n (n: arbitrary natural number) number of sub pixels constitute one pixel, and the long side of the rectangular screen be more than n times as long as short side.

Specifically, it is desirable that the arc tube array type display device be an arc tube array type display device of full-color display in which three sub pixels of red color (R), green color (G) and blue color (B) constitute one pixel, and the long side of the rectangular screen is more than three times as long as the short side.

In the configuration described above, the display is desirably so configured as to further include a front side support which is arranged on the display surface side of the arc tube array and contacts the arc tube array so as to support the arc tube array, and a back side support which is arranged on the back surface side of the arc tube array and contacts the arc tube array so as to support the arc tube array. In this case, the first electrodes and the second electrodes can be formed on a surface facing the arc tube array of the front side support, and the third electrodes can be formed on a surface facing the arc tube array of the back side support.

Further, the present invention provides a method of driving the arc tube array type display device as mentioned above, the method comprising the steps of: forming, at the time of screen display, one frame with a plurality of subfields having different brightness, and forming each subfield with at least an address period to select a light-emitting cell and a display period to cause the selected light-emitting cell to emit light; applying, in the address period, a scan voltage sequentially to the third electrodes provided with each of the arc tubes, and in the meantime, applying an address voltage to desired one of the first electrodes and second electrodes so that an address discharge takes place at an intersection between the third electrode and the one of the first electrodes and the second electrodes and a wall charge is formed in the light-emitting cell; and applying, in the display period, a sustain pulse alternately to the adjacent first electrode and second electrode so that a display discharge takes place in the light-emitting cell where the wall charge is formed in the arc tube to thereby perform screen display.

In the driving method mentioned above, it is desirable that a reset period to initialize wall charges of all light-emitting cells be provided before the address period of each subfield, and in the reset period, voltage pulse is applied to all first electrodes and second electrodes so as to cause reset discharge in all light-emitting cells.

Hereinafter, the present invention will be described in detail based on an embodiment shown in the drawings. Note that the present invention is not limited to this description, and various modifications are possible.

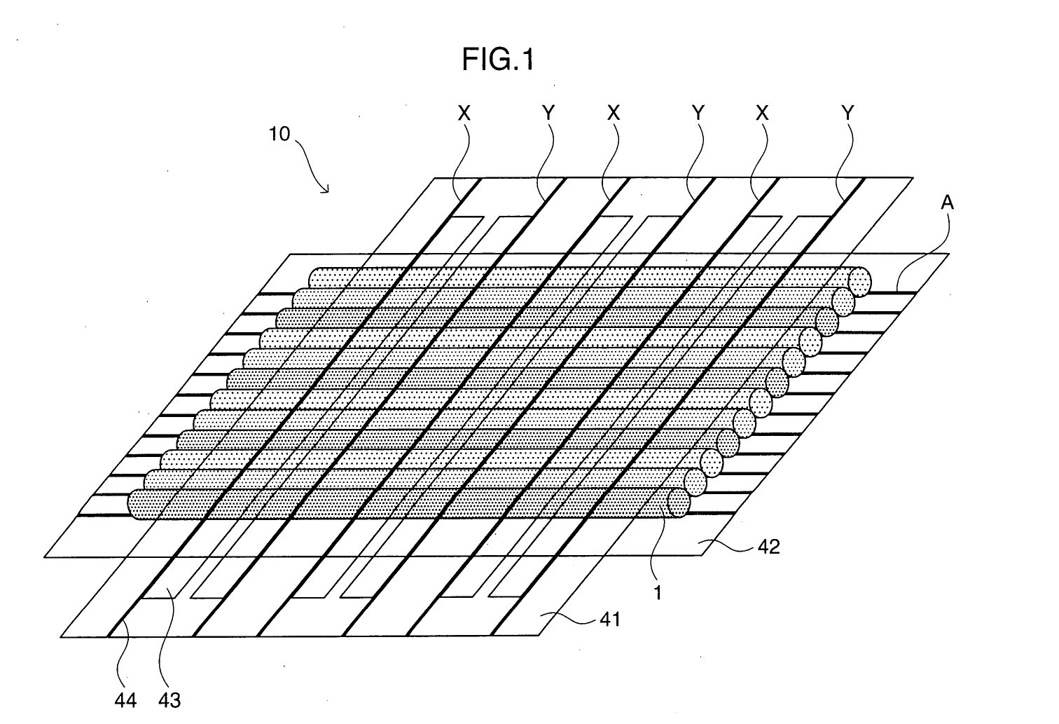

FIG. 1 is an illustration showing the overall configuration of the arc tube array type display device of the present invention. The display 10 is an arc tube array type display device in which phosphor layers are provided inside glass narrow tubes having a diameter of about 0.5 to 5 mm and a plurality of arc tubes filled with discharge gas are arranged in parallel to thereby display an image.

In FIG. 1, the reference numeral 1 denotes an arc tube, 41 denotes a support (substrate) on the front side (display surface side), 42 denotes a support (substrate) on the back surface side, X and Y denote first and second electrodes which are main electrodes, and A denotes a third electrode.

In the arc tube array type display device, an arc tube array is so configured that a plurality of arc tubes 1 are arranged in parallel in the row direction of the screen. That is, it is an arc tube array of a horizontal stripe structure in which arc tubes are arranged in a horizontal direction, and has such a configuration that the arc tube array is held between the front side support 41 and the back side support 42.

The front side support 41 and the back side support 42 are formed of flexible sheets like PET films. The front side support 41 is transparent. The back side support 42 is desirably opaque from the viewpoint of display contrast. The tube body of the arc tube 1 is made of borosilicate glass or the like.

On the surface facing the arc tubes of the front side support 41, a plurality of first and second electrodes X and Y in stripes are formed across the respective arc tubes. The first and second electrodes X and Y are used as display electrodes same as the conventional example, and are provided so as to contact the arc tubes 1 in a direction intersecting the third electrodes A. The first and second electrodes X and Y comprises transparent electrodes 43 such as ITO or SnO₂ and bus electrodes 44 made of metal such as nickel, copper, aluminum or chrome, respectively. These electrodes are formed by a method well known in the field such as sputtering, vapor deposition, plating or printing.

On the surface facing the arc tubes of the back side support 42, the third electrodes A are formed. The third electrodes A, which are for selecting a light-emitting cell same as the conventional case, are used as scan electrodes in the present invention, and are provided so as to contact the arc tubes 1 along the longitudinal direction of the arc tubes 1. The third electrodes are formed by using a metallic material such as nickel, copper, aluminum or silver, without using a transparent electrode material. These electrodes are also formed by a method well known in the field such as sputtering, vapor deposition, plating or printing. The third electrodes A may be formed directly on the outside walls of the arc tubes 1.

As described above, in the arc tube array type display device, the arc tubes 1 are arranged in the horizontal direction (row direction of the screen), and the first and second electrodes X and Y are arranged in the vertical direction on the front side of the arc tubes 1, and the third electrodes A are arranged in the horizontal direction on the back side of the arc tubes 1. In short, the first and second electrodes X and Y and the third electrodes A are arranged to be orthogonal to each other in a planar view of the display, and intersections between the first or second electrodes X or Y and the third electrodes A serve as unit light-emitting areas (unit discharge area: light-emitting cell).

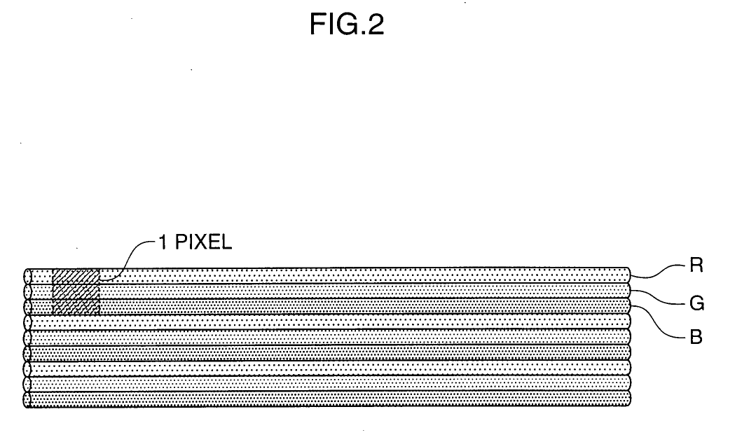

FIG. 2 is an illustration showing an exemplary arc tube arrangement of the arc tube arrays.

Each arc tube is an arc tube of single color for red (R), green (G) or blue (B). The arc tube array has a horizontal stripe structure in which these arc tubes of single color are arranged laterally in the order of R, G and B along the row direction of the screen as shown in FIG. 2.

As the tube body of an arc tube, a glass narrow tube is used. The narrow tube has a circular section, and is made of Pyrex (registered trademark: heat-resistant glass made by U.S. Corning Inc.) and fabricated to have a tube diameter of 0.7 to 1.5 mm, a film thickness of 0.07 to 0.1 mm and a length of 220 to 300 mm.

The narrow tube which is the tube body of the arc tube 1 is fabricated such that a cylindrical tube is fabricated by the Danner method, and the cylindrical tube is molded by heating so as to fabricate a glass matrix in the similar shape to the narrow tube to be formed, which is heated to be softened and redrawn (extended).

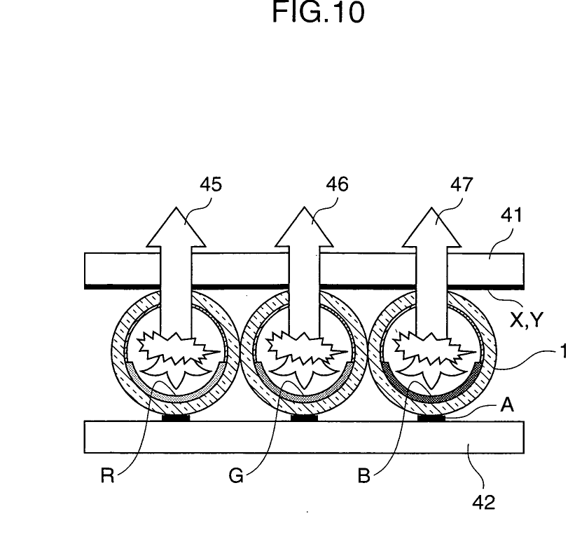

The inner structure of the arc tube is same as that shown in FIG. 10. That is, in the discharge spaces inside the arc tubes 1, phosphor layers of R (red), G (green) and B (blue) are arranged on the back side by respective colors, and discharge gas including neon and xenon is introduced, and the both ends are sealed, whereby a plurality of light-emitting cells of the same color are formed inside each arc tube.

When displaying, red light 45, green light 46 and blue light 47 are discharged from the arc tubes 1, and three light-emitting cells in adjacent three arc tubes for R, G and B constitute one pixel. For the inside of the arc tube, a structure well-known in the art as described in Japanese Patent Laid-Open Publication JP2003-86142A can be applied.

Although the arc tube of the present embodiment has a circular section, the arc tube is not limited to this. The tube may have any sectional shape such as ellipse, rectangle or trapezoid.

Next, a method of driving the arc tube array type display device of the present invention will be described.

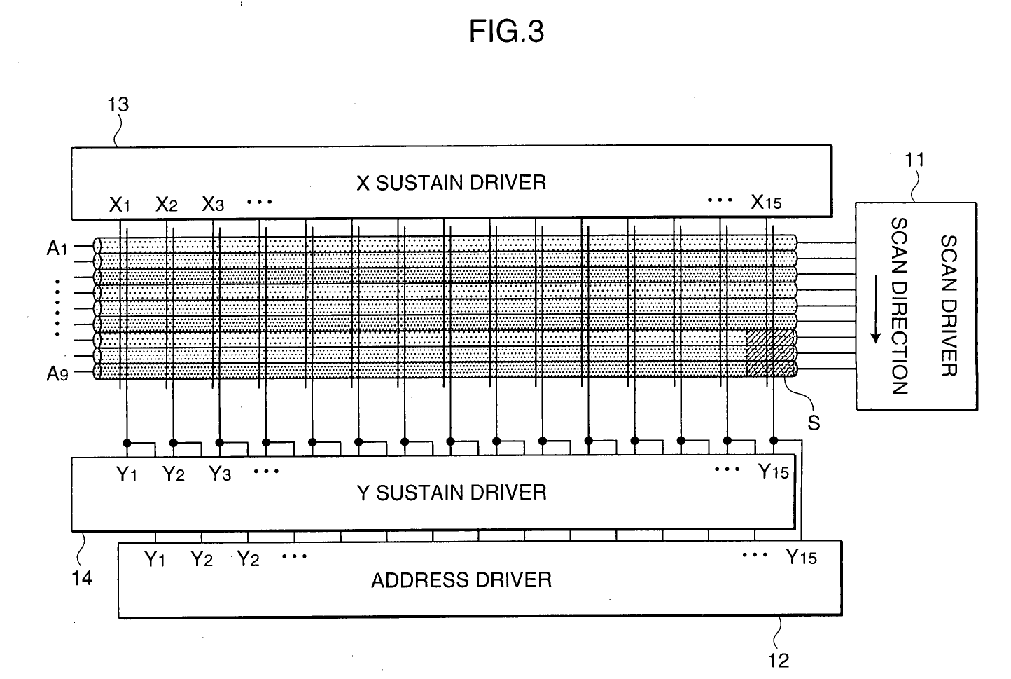

FIG. 3 is an illustration showing a driver arrangement of the arc tube array type display device.

In FIG. 3, the reference numeral 11 denotes a scan driver, 12 denotes an address driver, 13 denotes an X sustain driver, and 14 denotes a Y sustain driver.

One pixel S of display is formed at the intersection between third electrodes for three arc tubes of R, G and B and a pair of first and second electrodes X and Y intersecting the arc tubes. Therefore, in the arc tube array type display device shown, the aspect ratio of the screen is 1:5.

The scan driver 11 is connected with the third electrodes A, and in the address period, it applies scan pulse for selecting light-emitting cells to the third electrodes A. The address driver 12 is connected with the second electrodes Y, and in the address period, it applies address pulse for selecting light-emitting cells to the second electrodes Y. The X sustain driver 13 is connected with the first electrodes X, and in the display period, it applies sustain pulse to the second electrodes Y. The Y sustain driver 14 is connected with the second electrodes Y, and in the display period, it applies sustain pulse to the second electrode Y.

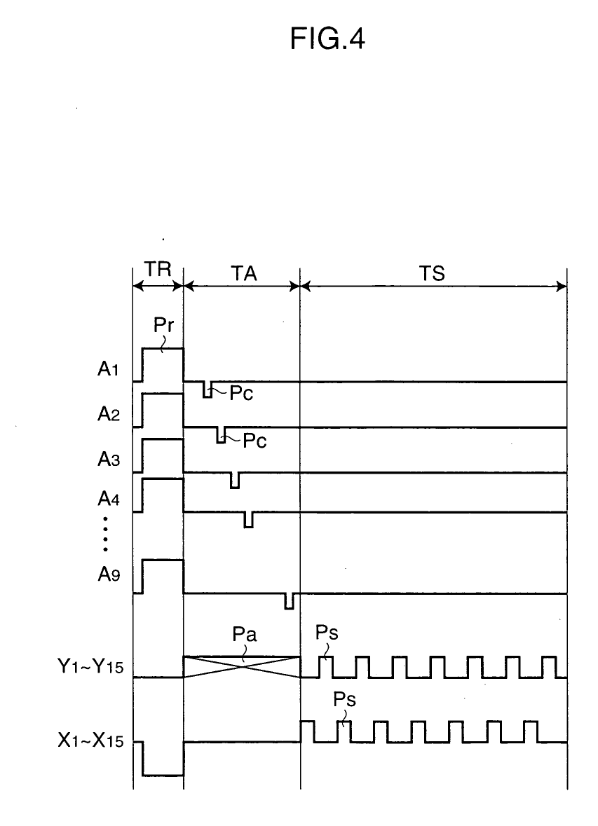

FIG. 4 is an illustration showing examples of driving voltage waveforms of the arc tube array type display device.

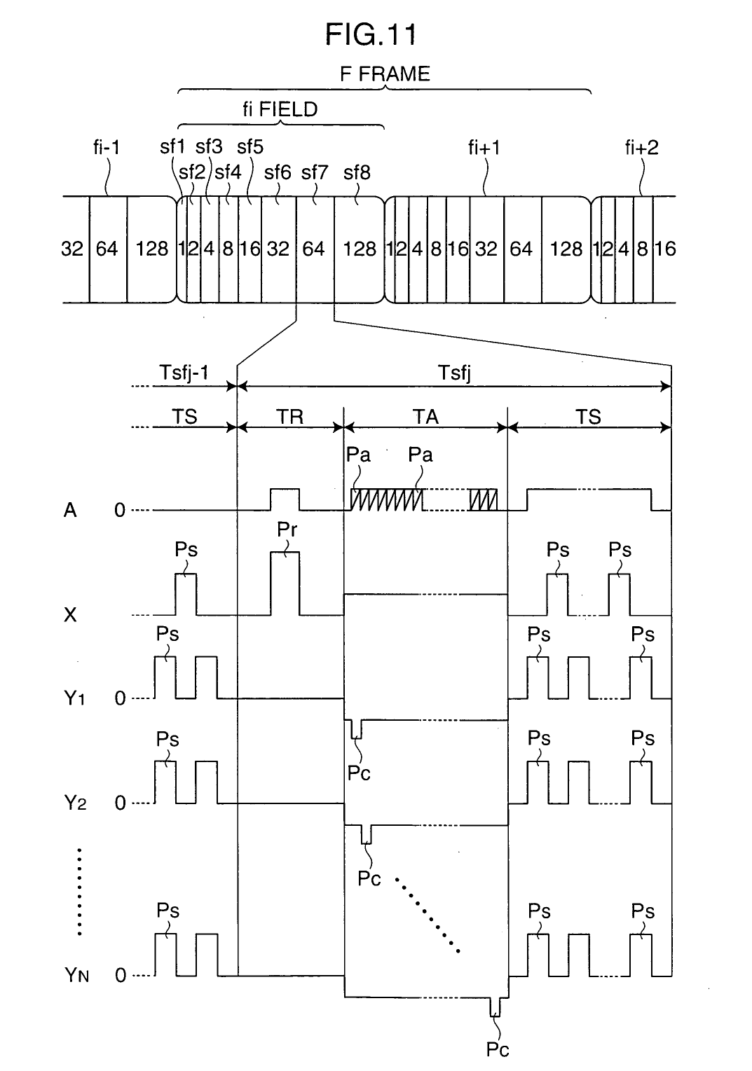

In the arc tube array type display device, when displaying, driving is performed by address-display separation type subfield method. Therefore, the field configuration is same as that shown in FIG. 11.

However, in the arc tube array type display device, the third electrodes A are used as scan electrodes and the second electrodes Y are used as address electrodes in the address period, as described above. An aspect of causing display discharge between the first and second electrodes X and Y is same as that shown in FIG. 11.

That is, one frame comprises eight subfields sf₁ to sf₈ having different brightness, for example. If one frame comprises two fields, each field fi comprises eight subfields sf₁ to sf₈, similarly. Relative weighting ratio of brightness of the eight subfields is 1:2:4:8:16:32:64:128.

Each subfield sfj includes a reset period TR to initialize wall charges of all light-emitting cells (uniform charged states), and an address period TA to select light-emitting cells, and a display period TS to sustain discharge of the light-emitting cells.

In the reset period TR, reset pulse Pr is applied simultaneously to the third electrodes A₁, A₂, A₃, . . . , A₉, to thereby cause reset discharge between the first electrode X₁ to X₁₅.

In the address period TA, the third electrodes A₁ to A₉ are used as scan electrodes, and scan pulse Pc is applied to the third electrodes A sequentially from the top, and in the meantime, address pulse Pa is applied to a desired second electrode Y so as to cause address discharge at the intersection between the third electrode A and the second electrode Y to thereby select a light-emitting cell.

In the display period TS, sustain pulse Ps is applied alternately to the first electrodes X and the second electrodes Y by using a wall charge formed in the light-emitting cell in the tube due to address discharge to thereby cause display discharge between the first and second electrodes X and Y.

Thereby, as shown by arrows in FIG. 10, red light 45 is discharged from the arc tube 1 in which the phosphor layer R for read is formed, green light 46 is discharged from the arc tube 1 in which the phosphor layer G for green is formed, and blue light 47 is discharged from the arc tube 1 in which the phosphor layer B for blue is formed.

Address discharge is opposite discharge caused inside the arc tube 1 between the third electrode A and the second electrode Y opposite to each other over the arc tube 1, and display discharge is surface discharge caused in the arc tube 1 between the two first and second electrodes X and Y arranged adjacently in parallel on a plane. With such an electrode arrangement, a plurality of light-emitting areas (unit light-emitting area: light-emitting cell) of the same color are formed in the longitudinal direction of the respective plural arc tubes arranged along the column direction of the screen.

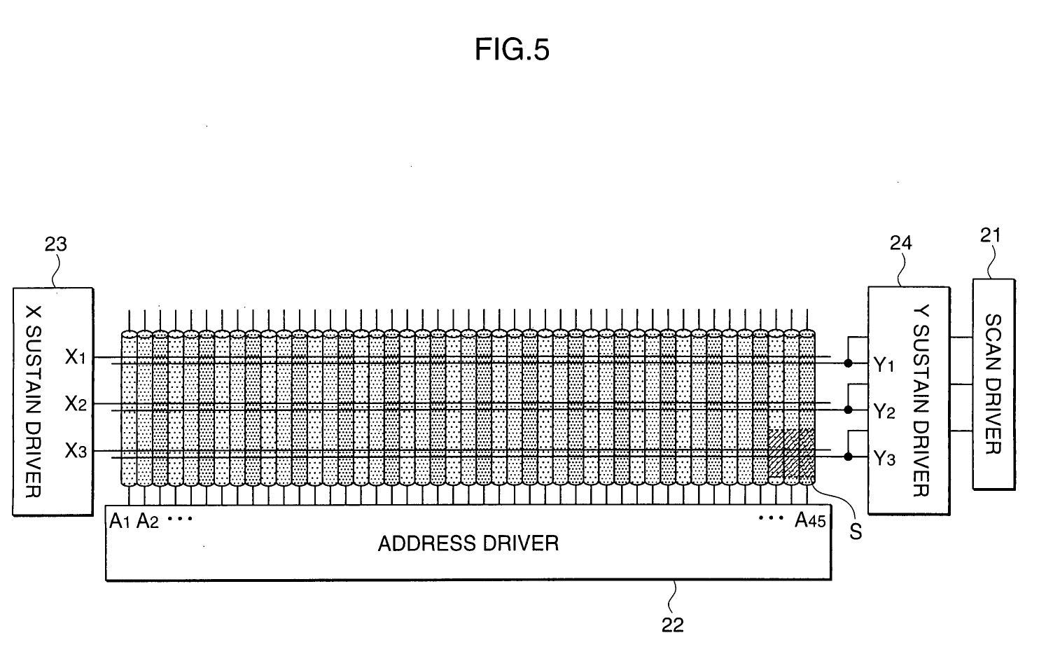

FIG. 5 is an illustration showing a comparative example 1 of the arc tube array type display device.

In this example, a plurality of arc tubes 1 are arranged in parallel in the row direction of the screen to thereby constitute an arc tube array. That is, it is an arc tube array of vertical stripe structure. The aspect ratio of the screen is 1:5 which is same as the embodiment described above.

In FIG. 5, the reference numeral 21 denotes a scan driver, 22 denotes an address driver, 23 denotes an X sustain driver, and 24 denotes a Y sustain driver.

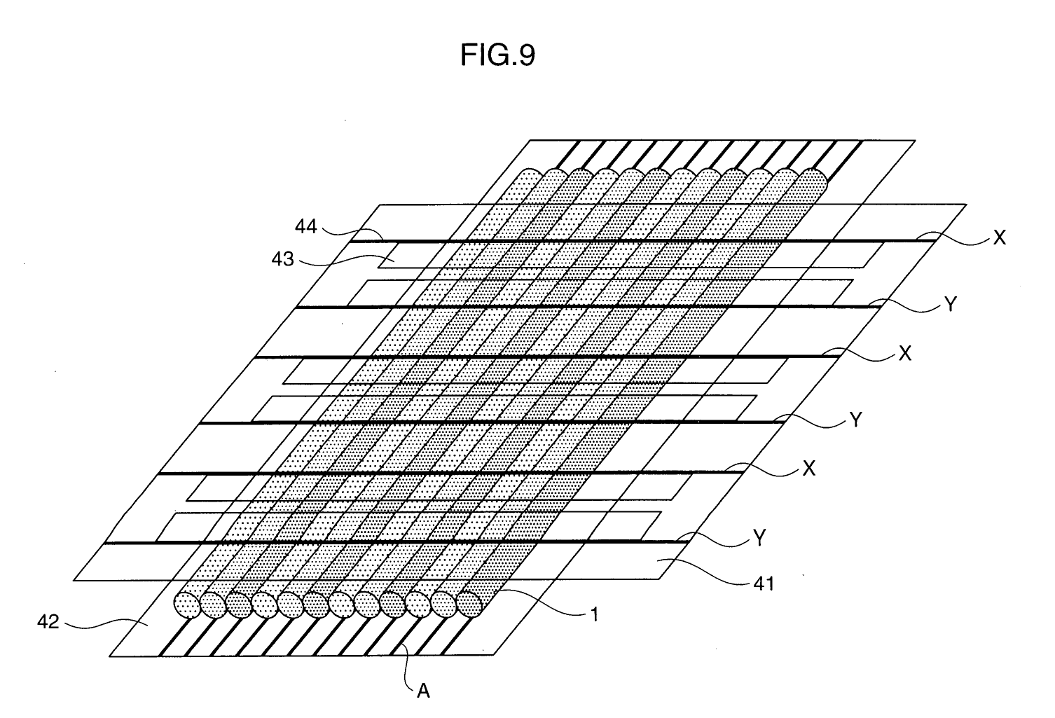

Connections of the drivers are same as those in the arc tube array type display device shown in FIG. 9. That is, the scan driver 21 is connected with the second electrodes Y, and in the address period, it applies scan pulse to the second electrodes Y. The address driver 22 is connected with the third electrodes A, and in the address period, it applies address pulse for selecting light-emitting cells to the third electrodes A. The X sustain driver 23 is connected with the first electrodes X, and in the display period, it applies sustain pulse to the first electrodes X. The Y sustain driver 14 is connected with the second electrodes Y, and in the display period, it applies sustain pulse to the second electrodes Y.

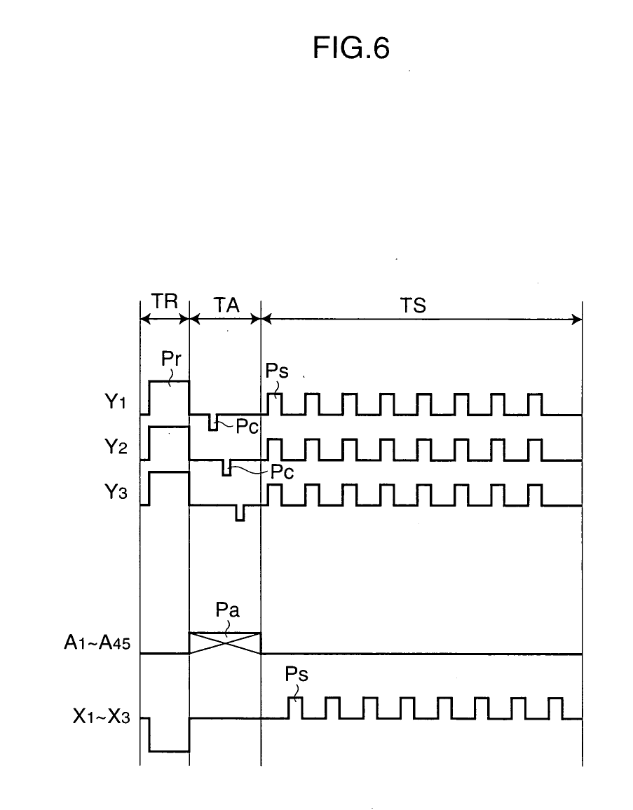

FIG. 6 is an illustration showing examples of driving voltage waveforms of the arc tube array type display device of the comparative example 1.

In the arc tube array type display device of the comparative example 1, driving voltage waveforms at the time of screen display performed by the address-display separation type subfield method become those shown in the drawing. In the display, the second electrodes Y are used as scan electrodes, and the third electrodes A are used as address electrodes.

That is, in the reset period TR, reset pulse Pr is applied simultaneously to the second electrodes Y₁, Y2, Y3 to thereby cause reset discharge with the first electrodes X₁, X₂, X₃.

In the address period TA, the second electrodes Y1, Y2, Y3 are used as scan electrodes, and scan pulse Pc is applied sequentially to the second electrodes Y from the top, and in the meantime, address pulse Pa is applied to a desired third electrode A so as to cause address discharge at the intersection between the third electrode A and the second electrode Y to thereby select a light-emitting cell.

In the display period TS, sustain pulse Ps is applied alternately to the first electrodes X and the second electrodes Y so as to cause display discharge between the first and second electrodes X and Y to thereby perform screen display.

In the arc tube array type display device of the comparative example 1, since a plurality of arc tubes are arranged along the row direction of the screen, enormous numbers of arc tubes are used, so the manufacturing cost increases.

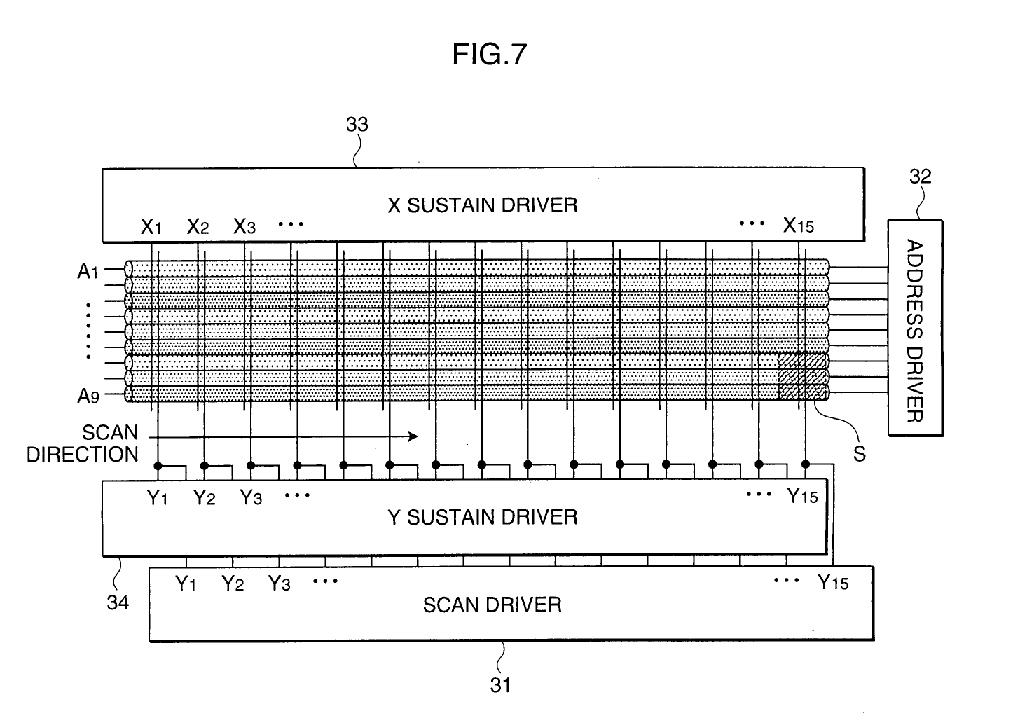

FIG. 7 is an illustration showing a comparative example 2 of the arc tube array type display device.

In this example, a plurality of arc tubes 1 are arranged in parallel along the column direction of the screen to thereby constitute an arc tube array. That is, it is an arc tube array of a horizontal stripe structure. The aspect ratio of the screen is 1:5 which is same as that of the embodiment described above. Therefore, only with the viewpoint of arrangement of the arc tube array, this example is same as the embodiment described above. However, a method of connecting the drivers described below is different from the embodiment described above.

In FIG. 7, the reference numeral 31 denotes a scan driver, 32 denotes an address driver, 33 denotes an X sustain driver, and 34 denotes a Y sustain driver.

The scan driver 31 is connected with the second electrodes Y, and in the address period, it applies scan pulse to the second electrodes Y. The address driver 32 is connected with the third electrodes A, and in the address period, it applies address pulse for selecting light-emitting cells to the third electrodes A. The X sustain driver 33 is connected with the first electrodes X, and in the display period, it applies sustain pulse to the first electrodes X. The Y sustain driver 34 is connected with the second electrodes Y, and in the display period, it applies sustain pulse to the second electrodes Y.

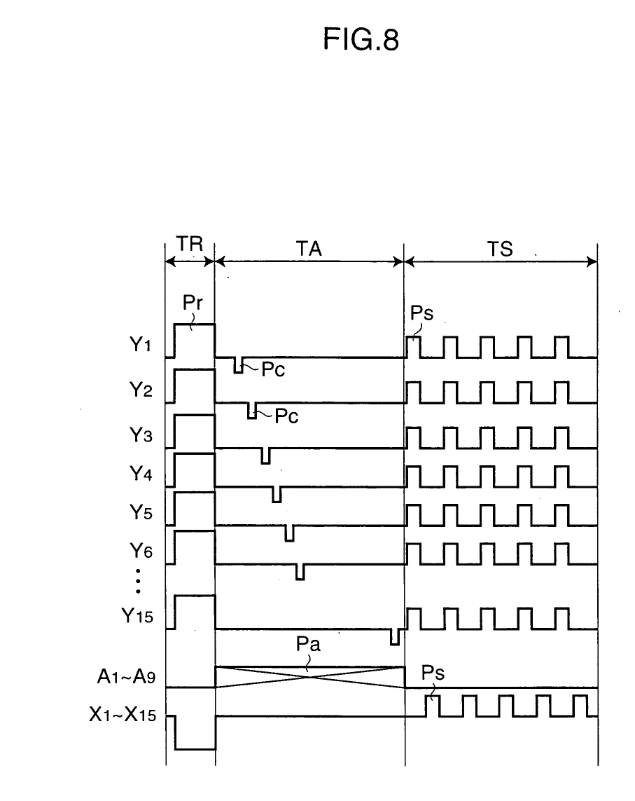

FIG. 8 is an illustration showing examples of driving voltage waveforms of the arc tube array type display device of the comparative example 2.

In the arc tube array type display device of the comparative example 2, driving voltage waveforms at the time of screen display performed by address-display separation type subfield method become those shown in the drawing. In this display, the second electrodes Y are used as scan electrodes, and the third electrodes A are used as address electrodes.

That is, in the reset period TR, reset pulse Pr is applied simultaneously to the second electrodes Y1, Y₂, Y₃ . . . , Y₁₅ to thereby cause reset discharge with the first electrodes X₁ to X₁₅.

In the address period TA, the second electrodes Y₁, Y₂, Y₃, . . . , Y₁₅ are used as scan electrodes, and scan pulse Pc is applied sequentially to the second electrodes Y from the left (or right), and the meantime, address pulse Pa is applied to a desired third electrode A so as to cause address discharge at the intersection between the third electrode A and the second electrode Y to thereby select a light-emitting cell.

In the display period TS, sustain pulse Ps is applied alternately to the first electrodes X and the second electrodes Y so as to cause display discharge between the first and second electrodes X and Y to thereby perform screen display.

In the arc tube array type display device of the comparative example 2, in the address period TA, scanning is performed by using second electrodes Y as scan electrodes, whereby the number of scan lines increases so the address period TA becomes longer. Correspondingly, the display period TS becomes shorter, so the display brightness becomes low.

As obvious from comparison between the comparative examples 1 and 2 described above, in the arc tube array type display device of the present embodiment, the arc tube array has a horizontal stripe structure, and the third electrodes provided so as to extend in the longitudinal direction of the arc tubes are used as scan electrodes. Thereby, it is possible to reduce the number of arc tubes used, to shorten the address period, and to improve the light-emitting brightness of the screen.

Specifically, in the case that the screen size of the arc tube array type display device is 100 cm vertically by 15 cm horizontally and the tube diameter of the arc tube is 1 mm for example, in the vertical stripe structure in which the arc tubes are arranged in the vertical direction, 1000 arc tubes are required.

On the other hand, in the horizontal stripe structure in which arc tubes are arranged in the horizontal direction according to the present embodiment, only 150 arc tubes are required.

Further, in the general driving method (driving method in which the second electrodes Y are used as scan electrodes), 1000 scan lines are required even in the case of horizontal stripe structure. Therefore, assuming that one scan time is 5 μs, it takes 5 ms until the scanning is completed.

On the other hand, in the driving method of the present embodiment, scanning is performed by using electrodes arranged along the longitudinal direction for the respective arc tubes, that is, third electrodes A, so only 150 scan lines are required. Therefore, assuming that one scan time (for one line) is 5 μs, the scan time becomes 750 μs, which is one sixth or less compared with the driving method described above.

As described above, in the arc tube array type display device, the arc tube array has a horizontal stripe structure, and scanning is performed by using the third electrodes provided for the respective arc tubes. Therefore, it is possible to reduce the number of arc tubes used, to shorten the address period, and to improve the light-emitting brightness of the screen.

Although the arc tube array type display device described in the embodiment has the screen aspect ratio of 1:5, if it is a full-color display, the effects described above can be achieved with the aspect ratio of 1:3 or more.

That is, when it is explained in general expression, in the case of an arc tube array type display device having a structure in which n (n: arbitrary natural number) number of arc tubes constitute one pixel, the effects described above can be achieved with the aspect ratio of 1:n or more.

1. An arc tube array type display device in which a plurality of arc tubes filled with discharge gas are arranged in parallel, comprising:
an arc tube array in which a plurality of arc tubes are arranged in parallel with the long side of a rectangular screen;
a plurality of first electrodes and second electrodes arranged on the display surface side of the arc tube array across the respective arc tubes in the direction intersecting a longitudinal direction of the arc tubes, so that display discharge takes place in an arc tube between the adjacent first electrode and second electrode; and
a plurality of third electrodes arranged on the back side of the arc tube array for the respective arc tubes along the longitudinal direction of the arc tubes, forming a light-emitting cell at an intersection with the first electrode or the second electrode,
wherein, at the time of screen display, the third electrodes provided with each of the arc tubes are used as scan electrodes and a scan voltage is applied sequentially to the plurality of third electrodes, and in the meantime, an address voltage is applied to a desired first electrode or second electrode so that an address discharge takes place in a desired light-emitting cell and a light-emitting cell is selected, and thereafter display discharge takes place between the adjacent first electrode and second electrode thus performing display.

2. The display device of claim 1, wherein the arc tube array includes a phosphor layer of a single color for each arc tube.

3. The display device of claim 1, which is an arc tube array type display device in which n (n: arbitrary natural number) number of sub pixels constitute one pixel, and the long side of the rectangular screen is more than n times as long as a short side.

4. The display device of claim 1, which is an arc tube array type display device of full-color in which three sub pixels for red color, green color and blue color constitute one pixel, and the long side of the rectangular screen is more than three times as long as a short side.

5. The display device of claim 1, further comprising:
a front side support arranged on the display surface side of the arc tube array, contacting the arc tube array so as to support the arc tube array; and
a back side support arranged on the back side of the arc tube array, contacting the arc tube array so as to support the arc tube array,
wherein the first electrodes and the second electrodes are formed on a surface facing the arc tube array of the front side support, and the third electrodes are formed on a surface facing the arc tube array of the back side support.

6. A method of driving the arc tube array type display device as claimed in claim 1, the method comprising the steps of:
forming, at the time of screen display, one frame with a plurality of subfields having different brightness, and forming each subfield with at least an address period to select a light-emitting cell and a display period to cause the selected light-emitting cell to emit light;
applying, in the address period, a scan voltage sequentially to the third electrodes provided with each of the arc tubes, and in the meantime, applying an address voltage to desired one of the first electrodes and second electrodes so that an address discharge takes place at an intersection between the third electrode and the one of the first electrodes and the second electrodes and a wall charge is formed in the light-emitting cell; and
applying, in the display period, a sustain pulse alternately to the adjacent first electrode and second electrode so that a display discharge takes place in the light-emitting cell where the wall charge is formed in the arc tube to thereby perform screen display.

7. The method of claim 6, wherein a reset period to initialize wall charges of all light-emitting cells is provided before the address period of each subfield, and in the reset period, a voltage pulse is applied to all of the first electrodes and the second electrodes for generating a reset discharge in all light-emitting cells.
